(19) United States
(12) Patent Application Publication
(10) Pub. No.: US 2014/0373691 A1
(43) Pub. Date: Dec. 25, 2014

(54) BIDIRECTIONAL TORQUE WRENCH

(71) Applicant: TORQUE-TECH PRECISION CO., LTD., Taichung (TW)

(72) Inventor: Tien-Lung LIN, Taichung (TW)

(21) Appl. No.: 13/923,835

(22) Filed: Jun. 21, 2013

(51) Int. Cl. B25B 23/14; B25B 23/142; B25B 13/06

(52) U.S. Cl. CPC B25B 23/141; B25B 13/06; B25B 23/142
USPC 81/480

(57) ABSTRACT

A bidirectional torque wrench includes a main body pivotally fixed thereon with an operating rod, and at least two resisting units are equiangularly and symmetrically assembled at the circumferential side of the operating rod. By so designing, in a process of operating the bidirectional torque wrench, the lateral forces acting on the resisting units are in opposite direction and able to be offset mutually to prevent the resisting units from shifting eccentrically for stabilizing torsion output, able to lower the torque force received by one single resisting unit and greatly enhance the maximum torsion value that the bidirectional torque wrench can output.

### BACKGROUND OF THE INVENTION

1. Field of the Invention

This invention relates to a bidirectional torque wrench.

2. Description of the Prior Art

A conventional torque wrench generally includes a main body pivotally provided thereon with an operating rod having a circumferential side circularly formed with a serrated portion. The main body is further disposed with a resisting unit composed of a spring and a steel ball that is positioned between the spring and the serrated portion. In using, the operating rod is first connected with a work piece, such as a bolt and the like, and then the main body is turned around to drive the operating rod to actuate the work piece to rotate for firmly locking the work piece in position. When the torsion the operating rod receives is larger than the elastic force of the spring, the steel ball will jump off the serrated portion to make the main body run idle for fixing the torsion and firmly locking the work piece, able to avoid applying excessive force and making the threads of the work piece get damaged in a locking process.

However, the conventional torque wrench is provided with only one set of the resisting unit to carry out unidirectional resisting against the serrated portion; therefore, in a using process, the conventional torque wrench will give rise to the following defects:

1. The lateral force produced during operating will make the resisting unit shift eccentrically and result in unstable output of torsion.

2. The elastic force offered by one single set of resisting unit is so small and hence the maximum torsion that the torque wrench can output is comparatively small.

3. The spring must be replaced with a new one in case the torsion value of the existing torque wrench is to be adjusted, inconvenient in use.

### SUMMARY OF THE INVENTION

The objective of this invention is to offer a bidirectional torque wrench able to stabilize torsion output and greatly elevate the maximum torsion value that the bidirectional torque wrench can output.

The bidirectional torque wrench in the present invention includes a main body provided with a shaft hole. At least two assembling grooves are equiangularly and symmetrically disposed around the shaft hole and communicate with the shaft hole, and an operating rod is pivotally secured with the shaft hole and has a circumferential wall annularly cut with a plurality of positioning recesses spaced apart at locations corresponding to the assembling grooves, the number of the positioning recesses being a multiple of the assembling grooves. At least two resisting units are respectively received in the assembling grooves, respectively composed of a resisting piece and an elastic piece positioned at one side of the resisting piece, opposite to the positioning recess, so that the resisting piece can be pushed by elasticity of the elastic piece to elastically resist the positioning recess of the operating rod.

The bidirectional torque wrench of this invention has the resisting units respectively assembled in the assembling grooves for two-way resisting the positioning recesses of the operating rod in an equiangular and symmetrical mode. Therefore, in a process of operating the bidirectional torque wrench, the lateral forces acting on the resisting units are in opposite direction and can be offset mutually, able to stop the resisting units from shifting eccentrically for stabilizing torsion output, and also lower the torsion that a single resisting unit receives for greatly elevating the maximum torsion value that the bidirectional torque wrench can output.

### BRIEF DESCRIPTION OF DRAWINGS

This invention will be better understood by referring to the accompanying drawings, wherein:

FIG. 1 is a perspective view of a first preferred embodiment of a bidirectional torque wrench in the present invention;

FIG. 2 is an exploded perspective view of the first preferred embodiment of the bidirectional torque wrench in the present invention;

FIG. 3 is a cross-sectional view of the first preferred embodiment of the bidirectional torque wrench in the present invention;

FIG. 4 is an action schematic view of the first preferred embodiment of the bidirectional torque wrench in the present invention, illustrating that two resisting units respectively resist the positioning recesses of an operating rod;

FIG. 5 is an action schematic view of the first preferred embodiment of the bidirectional torque wrench in the present invention, illustrating that the two resisting units are respectively disengaged from the positioning recesses of the operating rod;

FIG. 6 is an action schematic view of the first preferred embodiment of the bidirectional torque wrench in the present invention, showing a condition of regulating two adjusting members;

FIG. 7 is a cross-sectional view of a second preferred embodiment of a bidirectional torque wrench in the present invention; and

FIG. 8 is a cross-sectional view of a third preferred embodiment of a bidirectional torque wrench in the present invention.

### DETAILED DESCRIPTION OF THE PREFERRED EMBODIMENT

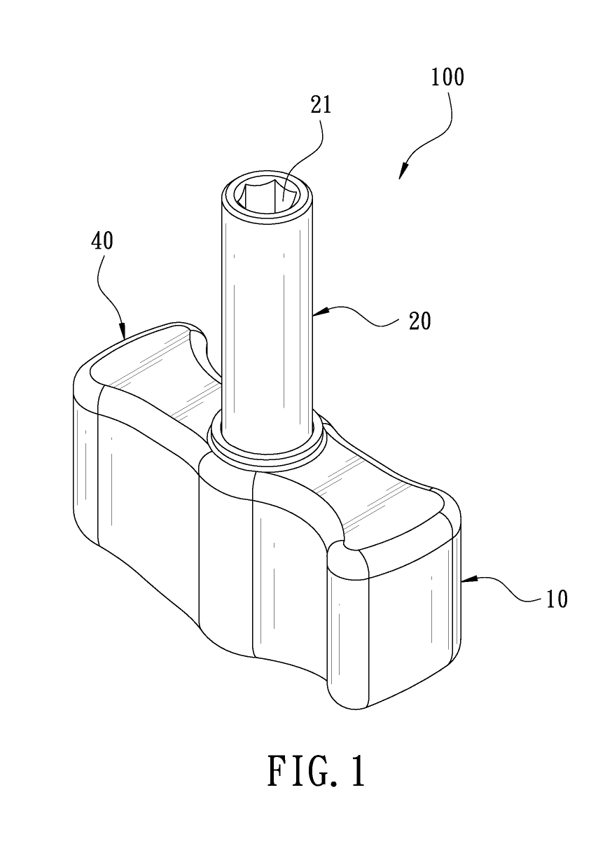

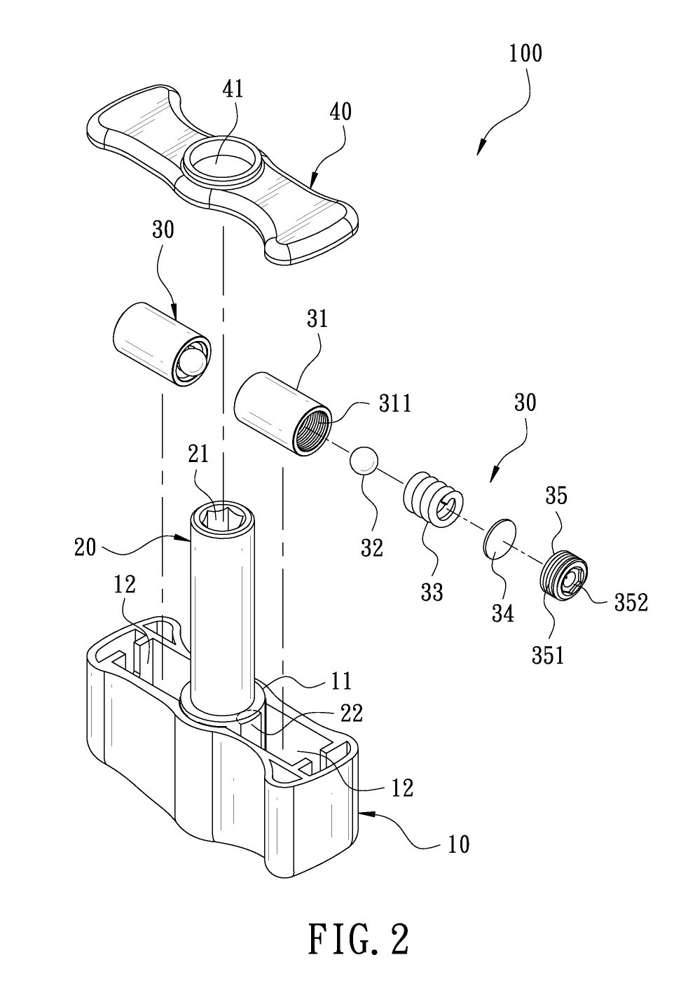

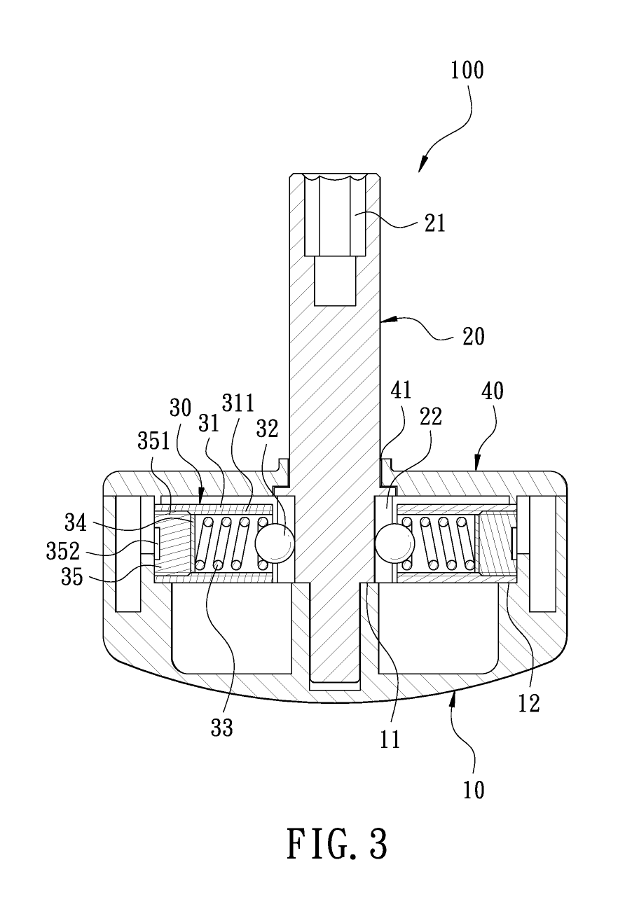

A first preferred embodiment of a bidirectional torque wrench 100 in the present invention, as shown in FIGS. 1, 2 and 3, includes a main body 10, an operating rod 20, at least two resisting units 30 and a cover 40 as main components combined together. The main body 10 is formed with a shaft hole 11 and at least two assembling grooves 12 that are equiangularly and symmetrically positioned around the shaft hole 11 and communicate with the shaft hole 11. In this preferred embodiment, the main body 10 is provided with two assembling grooves 12 positioned at 180 degrees.

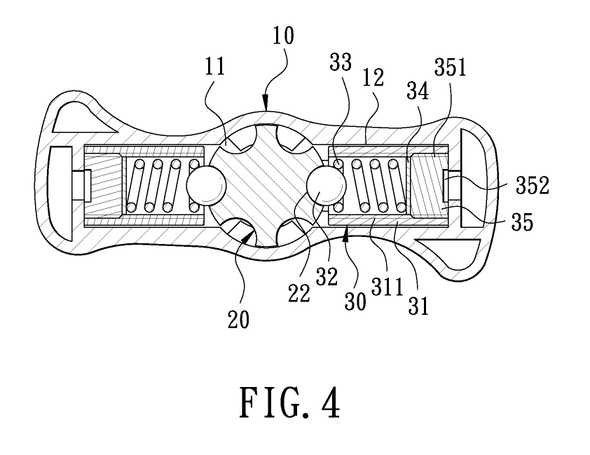

The operating rod 20 has one end pivotally secured in the shaft hole 11 and another end protruding out of the shaft hole 11 and disposed with a connecting slot 21 for connecting a tool head such as a sleeve employed for locking a bolt or the like. Further, the operating rod 20 has a circumferential wall annularly disposed with a plurality of positioning recesses 22 spaced apart at locations corresponding to the two assembling grooves 12, and the number of the positioning recesses 22 is the multiple of the assembling grooves 12. In this preferred embodiment, the operating rod 20 is formed with six positioning recesses 22, as shown in FIG. 4.

The two resisting units 30 are respectively mounted in the two assembling grooves 12. Each resisting unit 30 consists of a tube 31 having female threads 311 provided at the inner wall. A resisting piece 32, which is a steel ball in this preferred embodiment, is received in the tube 31, and an elastic piece 33, which is a spring in this preferred embodiment, is positioned at one side of the resisting piece 32, opposite to the positioning recess 22, so that the resisting piece 32 can be pushed by elasticity of the elastic piece 33 for elastically resisting the positioning recess 22. A press plate 34 is set at another end of the elastic piece 33, and an adjusting member 35 is fixed at one side of the press plate 34, opposite to the elastic piece 33, having a circumferential side provided with male threads 351 to be meshed with the female threads 311 of the tube 31 so that the adjusting member 35 can be threadably moved and adjusted in position in the tube 31. The adjusting member 35 further has one side opposite to the press plate 34 bored with a polygonal groove 352.

The cover 40 is covered around the outer sides of the assembling grooves 12, bored with an insert hole 41 at a location corresponding to the shaft hole 11 of the main body 10 for the operating rod 20 to be inserted therethrough.

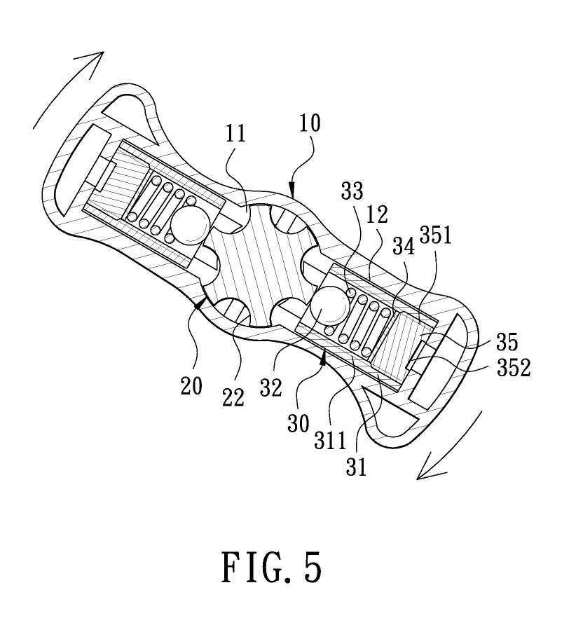

Referring to FIGS. 4 and 5, since the resisting piece 32 is pushed by the elasticity of the elastic piece 33 for elastically resisting the positioning recess 22 of the operating rod 20; therefore, when the bidirectional torque wrench 100 is used, and if the torsion that the operating rod 20 receives is less than the elasticity of the elastic piece 33, the main body 10 can be turned around to drive the operating rod 20 to rotate, as shown in FIG. 4. On the contrary, if the torsion received by the operating rod 20 is larger than the elasticity of the elastic piece 33, the resisting pieces 32 will be disengaged from the positioning recesses 22 of the operating rod 20 and unable to actuate the operating rod 20 to rotate, as shown in FIG. 5. Thus, a work piece can be firmly locked by fixed torsion to avoid applying excessive force and making the threads of the work piece get damaged.

What is worth noting is that the resisting units 30 are respectively assembled in the two assembling grooves 12 and equiangularly and symmetrically resist the positioning recesses 22 of the operating rod 20 and as stated above, in this preferred embodiment, two resisting units 30 are provided to carry out two-way and 180 degrees resisting against the operating rod 20. Therefore, in a process of operating the bidirectional torque wrench 100, the lateral forces acting on the two resisting units 30 are in opposite direction and able to be offset mutually. By so designing, the resisting units 30 can be prevented from shifting eccentrically for stabilizing torsion output, and the torsion received by one single resisting unit 30 can be lowered, able to greatly elevate the maximum torsion value that the bidirectional torque wrench 100 can output.

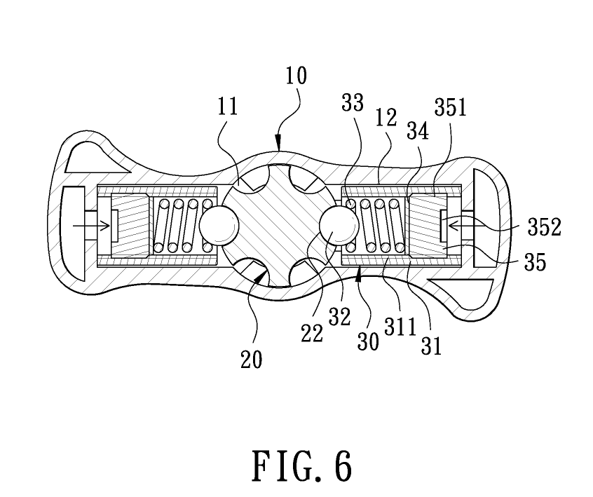

Referring to FIG. 6, since the adjusting member 35 is screwed with the tube 31; therefore, a user can have an adjusting tool inserted in the polygonal groove 352 of the adjusting member 35 to drive the adjusting member 35 to move threadably in the tube 31 for regulating the position of the adjusting member 35 relative to the tube 31 and adjusting the elasticity of the elastic piece 33. For instance, the adjusting member 35 can be regulated to move toward the resisting piece 32 to press the elastic piece 33 for enhancing the elasticity of the elastic piece 33, thus facilitating adjustment of the torsion that the bidirectional torque wrench 100 outputs.

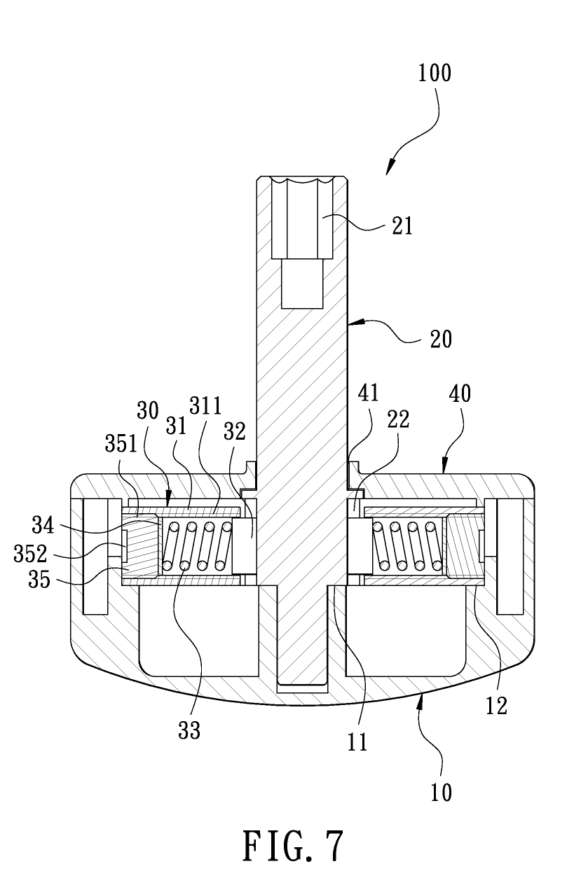

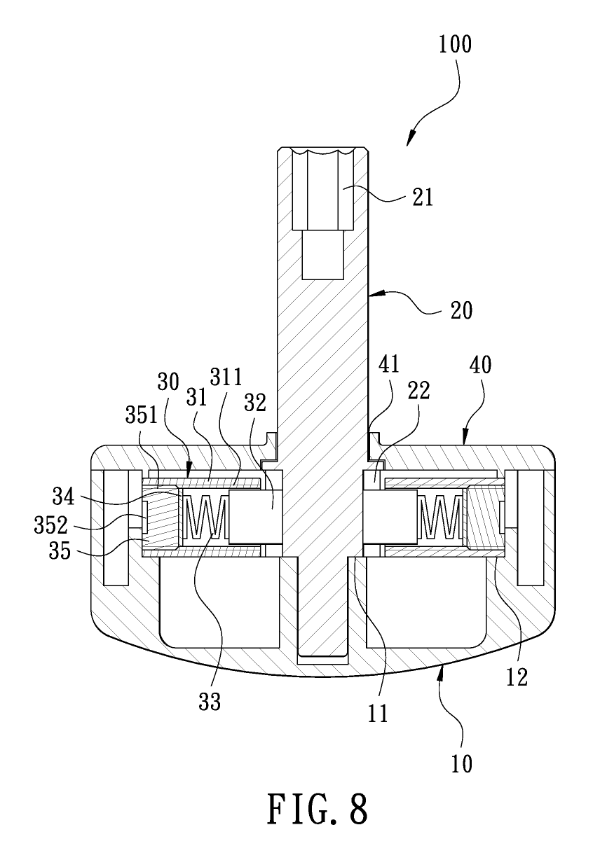

A second and a third preferred embodiments of a bidirectional torque wrench 100 in the present invention, are shown in FIGS. 7 and 8, separately having the resisting piece 32 and the elastic piece 33 of the resisting unit 30 in the first preferred embodiment replaced with a roller pin cooperating with a spring as shown in FIG. 7, or replaced with a slide block and a leaf spring, as shown in FIG. 8. Thus, the resisting units 30 can equally resist the positioning recess 22 of the operating rod 20 with an equiangular and symmetrical mode, able to attain the same efficacies of stabilizing torsion output and elevating maximum torsion output as previously stated in the first preferred embodiment.

While the preferred embodiments of the invention have been described above, it will be recognized and understood that various modifications may be made therein and the appended claims are intended to cover all such modifications that may fall within the spirit and scope of the invention.

What is claimed is:

1. A bidirectional torque wrench comprising:
a main body provided with a shaft hole, and at least two assembling grooves equiangularly and symmetrically disposed around said shaft hole, said assembling grooves communicating with said shaft hole;
an operating rod pivotally fixed with said shaft hole, said operating rod having an circumferential wall annularly formed with a plurality of positioning recesses spaced apart at locations corresponding with said assembling grooves, number of said positioning recesses being a multiple of said assembling grooves; and
at least two resisting units respectively received in said assembling grooves, each said resisting unit provided with a resisting piece, and an elastic piece positioned at one side of said resisting piece, opposite to said positioning recess, said resisting piece pushed by elasticity of said elastic piece to elastically resist said positioning recess.

2. The bidirectional torque wrench as claimed in claim 1, wherein each said resisting unit is further provided with a tube, said tube having an inner wall formed with female threads, said tube received therein with said resisting piece, said elastic piece positioned at one side of said resisting piece, opposite to said positioning recess, a press plate set at another end of said elastic piece, an adjusting member disposed at one side of said press plate, opposite to said elastic piece, said adjusting member having a circumferential wall formed with male threads, said male threads engaged with said female threads of said tube to enable said adjusting member to be threadably regulated in position in said tube, said adjusting member formed with a polygonal groove at one side opposite to said press plate.

3. The bidirectional torque wrench as claimed in claim 2, wherein said resisting piece is a steel ball while said elastic piece is a spring.

4. The bidirectional torque wrench as claimed in claim 2, wherein said resisting piece is a roller pin while said elastic piece is a spring.

5. The bidirectional torque wrench as claimed in claim 2, wherein said resisting piece is a slide block and said elastic piece is a leaf spring.

6. The bidirectional torque wrench as claimed in claim 1, wherein a cover is covered around outer sides of said assembling grooves, said cover bored with an insert hole at a location corresponding to said shaft hole for said operating rod to be inserted therethrough.

7. The bidirectional torque wrench as claimed in claim 1, wherein said main body is provided with two assembling grooves, and said operating rod is disposed with six positioning recesses.
